(19) United States
(12) Patent Application Publication
(10) Pub. No.: US 2008/0127799 A1
(43) Pub. Date: Jun. 5, 2008

(54) MUSICAL KEYBOARD INSTRUMENT

(75) Inventors: Masayoshi Yamashita, Hamamatsu-shi (JP); Shuichi Sawada, Hamamatsu-shi (JP); Hideo Suzuki, Hamamatsu-shi (JP); Yoshinori Hayashi, Iwata-shi (JP); Emiko Suzuki, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-shi (JP)

(21) Appl. No.: 11/935,336

(22) Filed: Nov. 5, 2007

(30) Foreign Application Priority Data
Nov. 7, 2006 (JP) 2006-301566

(51) Int. Cl. G10C 3/12; G10C 3/20; G10B 3/10

(52) U.S. Cl. 84/244; 84/423 R; 84/258; 84/337

(57) ABSTRACT

In a musical keyboard instrument, a keyboard having a plurality of keys that pivotally move about a frame is mechanically isolated from a tone generator having a plurality of operating members allowing musical tones to be generated in response to the keys being depressed. A plurality of key-depression detection devices are arranged for the keys so as to detect the key-depression operations applied to the keys. A drive control device drives the operating members so as to generate musical tones in response to key-depression signals output from the key-depression detection devices upon detection of the key-depression operations applied to the keys. Thus, it is possible for the player, in particular, a weak person, to easily and rapidly perform key-depression operations, thus realizing desired musical performance of the musical keyboard instrument.

### BACKGROUND OF THE INVENTION

1. Field of the Invention

The present invention generally relates to musical keyboard instruments, and in particular to electronic pianos and player pianos that generate musical ones by way of musical performance on keyboards.

This application claims priority on Japanese Patent Application No. 2006-301566, the content of which is incorporated herein by reference.

2. Description of the Related Art

Conventionally, musical keyboard instruments such as acoustic pianos and electronic pianos (or electronic keyboard instruments) are each designed such that keys are independently driven by, actuators such as solenoids Japanese Unexamined Patent Application Publication No. H02-254494 teaches an example of a player piano that is capable of automatically playing a musical performance when solenoids are independently driven so as to move keys incorporated in a keyboard.

In this type of the musical keyboard instrument, actuators (e.g., solenoids) are independently activated so as to drive the corresponding keys in response to performance information (designating a series of musical tones forming a musical tune), thus automatically playing a musical performance. The keys are equipped with position sensors in the musical keyboard instrument; hence, the actuators are appropriately activated based on detection results of the position sensors during the automatic performance, thus appropriately driving the keys.

In acoustic musical keyboard instruments such as acoustic pianos, hammers are driven to strike strings so as to generate acoustic sounds, wherein hammers and their associated parts are each heavy-weighted in the low register compared with the high register, that is, relatively high depression force must be required to drive the keys belonging to the low register compared with the keys belonging to the high register. This makes it difficult for the player to rapidly depress keys. In particular, relatively weak players such as beginners, children, and middle-aged persons experience difficulty in playing acoustic musical keyboard instruments.

The aforementioned problem cannot be solved by the technology disclosed in Japanese Unexamined Patent Application Publication No. H02-254494. This is because the conventionally-known technology simply teaches that keys are driven by actuators during automatic performance, wherein it does not teach a reduction of the depression force required for driving each key during manual performance.

### SUMMARY OF THE INVENTION

It is an object of the present invention to provide a musical keyboard instrument that allows a player, in particular, a weak person, to rapidly depress keys in manual performance.

A musical keyboard instrument according to the present invention includes a keyboard having a plurality of keys that pivotally move about a frame, a tone generator having a plurality of operating members allowing musical tones to be generated in response to the keys being depressed, a plurality of key-depression detection devices that are arranged for the keys so as to detect key-depression operations applied to the keys, and a drive control device for driving each of the operating members so as to generate a musical tone in response to a key-depression signal output from each of the key-depression detection devices upon detection of a key-depression operation applied to each of the keys.

The musical keyboard instrument can be designed to simulate an acoustic piano, a harpsichord, and a pipe organ, for example. In the case of an acoustic piano, the operating member corresponds to a hammer for striking a string so as to generate a musical tone. In the case of a harpsichord, the operating member corresponds to a plectrum for picking a string so as to generate a musical tone. In the case of a pipe organ, the operating member corresponds to a palette for opening and closing a hole so as to control an air flow blown into a sound pipe.

When a player performs manual performance on the musical keyboard instrument, the key-depression detection devices output key-depression signals upon key-depression operations manually applied to the keys, so that the drive control device drives the operating members so as to generate musical tones in response to key-depression signals. The present invention is characterized in that the keyboard is mechanically isolated from the tone generator, in other words, the keys are mechanically isolated from the operating members; hence, in contrast to acoustic musical keyboard instruments conventionally known, the weights of the operating members and the initial forces normally applied to the operating member being set to initial positions are not transmitted to the keys irrespective of key-depression operations. This allows the player to make the musical keyboard instrument generate musical tones by way of only the depression forces applied to the keys. That is, it is possible to realize brand-new key-touch sensations of the keys, which are not affected by the weights and initial forces of the operating members in key-depression operations.

In addition, the present invention makes it possible to easily replace the keyboard attached to the tone generator with another one. This makes it possible to use various keyboards attached to the same tone generator, thus generating musical tones with various key-touch sensations of keys. Alternatively, it is possible to easily replace the tone generator attached to the keyboard with another one. This makes it possible to use various tone generators attached to the same keyboard, thus generating musical tones of various tone colors without changing key-touch sensations of keys.

In the above, the drive control device includes a plurality of actuators, which are installed in the tone generator so as to drive the operating members, a memory for storing the relationship between the key-depression signals and drive control signals, and a controller for controlling the actuators in response to drive control signals, which are read from the memory in response to key-depression signals output from the key-depression detection devices upon detection of key-depression operations applied to the keys.

Furthermore, the musical keyboard instrument further includes au octave selector for selecting the operating members in units of octaves in correspondence with the keys included in the keyboard, wherein the drive control device drives the operating members selected by the octave selector so as to generate the corresponding musical tones.

As described above, the present invention offers a variety of effects and technical features, as follows:
(1) Since the musical keyboard intent of the present invention is capable of generating musical tones in response to only the key-depression forces applied to the keys to pivotally move about the frame, it is possible for the player, in particular, a weak person, to easily and rapidly perform key-depression operations with relatively small force.
(2) Since the keyboard is mechanically isolated from the tone generator, the player has freedom in selecting the keyboard realizing desired key-touch sensations suited to the player's preference. Alternatively, it is possible for the player to use various tone colors in a musical performance without changing key-touch sensations of keys.
(3) The controller receives key-depression signals from the key-depression detection devices so as to output drive control signals to the actuators, wherein the keyboard having the keys and key-depression detection devices is mechanically isolated from the tone generator having the controller, actuators, and operating members (and associated parts such as strings).
(4) Due to the provision of the octave selector that selects the operating members and associated parts in correspondence with the keys, it is possible to use the keyboard in which the number of keys is smaller than the number of the operating members, wherein the player is capable of playing a musical performance using a relatively large number of sound sources realized by the tone generator.
(5) By appropriately changing the sound sources being selected by the octave selector, it is possible for the player to play a musical performance using a relatively large number of sound sources without greatly moving the player's arms.

### BRIEF DESCRIPTION OF THE DRAWINGS

These and other objects, aspects, and embodiments of the present invention will be described in more detail with reference to the following drawings, in which:

FIG. 1 diagrammatically shows essential parts of a musical keyboard instrument, i.e., a keyboard and a tone generator, in accordance with a preferred embodiment of the present invention;

FIG. 2 diagrammatically shows a pressure sensor and a position sensor, which is arranged in connection with each of keys included in the keyboard of the musical keyboard instrument;

FIG. 3 is a block diagram showing the electronic constitution of the keyboard and the tone generator interconnected together via a connector;

FIG. 4 is a block diagram showing the electronic constitution of the keyboard and tone generator installed in a musical keyboard instrument according to a first variation;

FIG. 5 diagrammatically shows a velocity sensor attached to a key installed in a musical keyboard instrument according to a second variation;

FIG. 6 diagrammatically shows an acceleration sensor attached to a key installed in a musical keyboard instrument according to a third variation;

FIG. 7 diagrammatically shows a polymer actuator attached to a hammer installed in a musical keyboard instrument according to a fourth variation;

FIG. 8 diagrammatically shows an actuator composed of a shape memory alloy attached to a hammer installed in a musical keyboard instrument according to a fifth variation; and

FIG. 9 diagrammatically shows a tone generator simulating a tone-generation mechanism of a pipe organ, which is installed in a musical keyboard instrument according to a sixth variation.

### DESCRIPTION OF THE PREFERRED EMBODIMENT

The present invention will be described in further detail by way of examples with reference to the accompanying drawings.

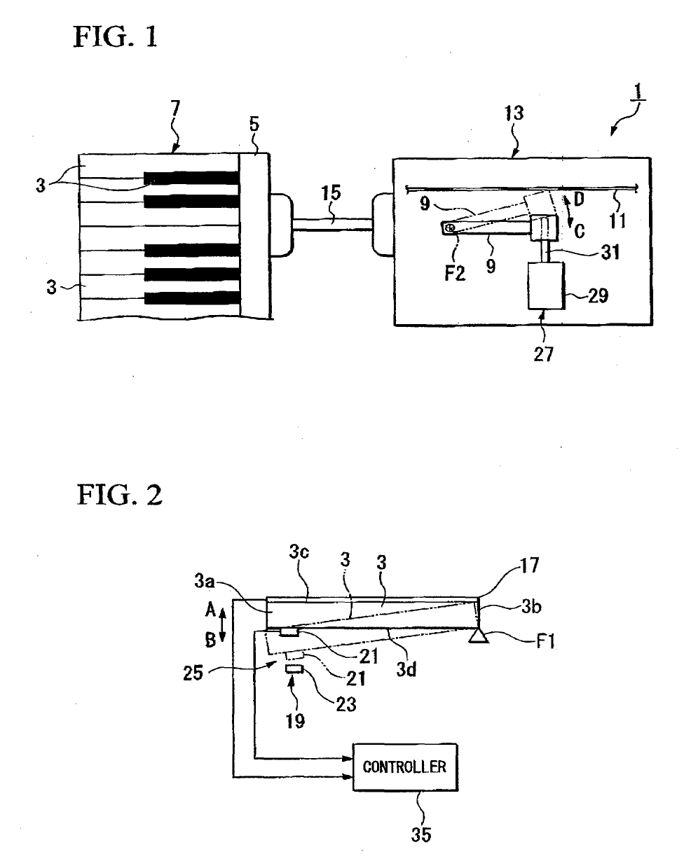

A musical keyboard instrument according to a preferred embodiment of the present invention will be described with reference to FIGS. 1 to 3.

FIG. 1 shows a musical keyboard instrument 1 equipped with a keyboard 7, which includes a plurality of keys 3 that are pivotally supported by a frame 5, and a tone generator 13, which generates musical tones when hammers 9 strike strings 11. That is, the tone generator 13 of the musical keyboard instrument 1 is basically designed similar to the conventionally-known tone-generation mechanism installed in an acoustic piano, wherein the tone generator 13 includes the hammers 9 and the strings 11. The keyboard 7 and the tone generator 13 are electrically connected together via a “freely detachable” connector 15.

FIG. 2 shows that each of the keys 3 installed in the keyboard 7 is capable of pivotally moving in directions A-B about a supporting point F1 on a rear-end portion 3b thereof. The key 3 is equipped with a spring and a weight (both not shown) allowing it to be normally returned to an initial position thereof; wherein the key 3 is normally pressed in the direction A. Specifically, when a player depresses a surface 3c of the key 3 with his/her finger, the musical keyboard instrument 1 performs a key-expression operation making the key 3 pivotally move in the direction B, which is reverse to the direction A.

Each of the keys 3 installed in the musical keyboard instrument 1 is equipped with a pressure sensor 17 for detecting depression pressure applied to the surface 3c at the front-end portion 3a and a position sensor 19 for detecting the position of the front-end portion 3a being depressed.

The pressure sensor 17 is formed in a film-like shape, which is adhered onto the surface 3c of the key 3. For example, the pressure sensor 17 is formed using a piezoelectric element for converting the depressing pressure (applied to the surface 3c of the key 3 with the player's finger) into voltage. That is, the pressure sensor 17 detects whether or not the player's finger comes in contact with and depresses the Surface 3c of the key 3, thus detecting a key-depression operation.

The position sensor 19 is constituted of a Hall element 21, which is attached to a backside 3d of the key 3 at the front-end portion 3a so as to detect a magnetic field strength in the form of voltage, and a magnet 23, which is fixed to the frame 5 and is positioned opposite to the Hall element 21.

The Hall element 21 is distanced from the magnet 23 in the initial position of the key 3 that is not depressed, whereas when the key 3 pivotally moves in the direction B, the Hall element 21 moves close to the magnet 23. The magnitude of a voltage detected by the Hall element 21 is relatively small as the Hall element 21 is distanced from the magnet 23, while it becomes large as the Hall element 21 moves close to the magnet 23. That is, the position sensor 19 is capable of detecting the position of the key 3 being pivotally moved in the form of the magnitude of a voltage.

The constitution of the position sensor 19 is not necessarily limited to the aforementioned constitution shown in FIG. 2. For example, the position sensor 19 can be modified in such a way that the magnet 23 is fixed to the backside 3d of the key 3, and the Hall element 21 is fixed in position in proximity to the frame 5. It is simply required that the position sensor 19 be capable of detecting the position of the key 3 being pivotally moved; hence, the position sensor 19 can be configured in the form of an optical sensor, for example.

The pressure sensor 17 and the position sensor 19, which are attached to the key 3, form a sensor unit (or a key-depression detection device) 25 for detecting a key-depression operation of the key 3. Electric signals (or voltages) output from the pressure sensor 17 and the position sensor 19 serve as key-depression signals, which are output to a controller 35.

As shown in FIG. 1, the number of the strings 11 installed in the tone generator 13 is identical to the number of the keys installed in the keyboard 7; and each single hammer 9 is arranged for each single string 11. The hammer 9 is attached to a frame (not shown) of the tone generator 13 and is capable of pivotally moving about a supporting point F2 in directions C-D. The hammer 9 is normally dressed in the direction C due to its own weight; hence, when the hammer 9 pivotally moves in the direction D, the hammer 9 strikes the string 11.

The tone generator 13 is equipped with an actuator 27 for driving the hammer 9 in the direction D. The actuator 27 is constituted of a solenoid coil 29, which is positioned beneath the hammer 9 and is fixed to the frame, and a plunger 31 having magnetic property, which is inserted into the solenoid coil 29 and comes into contact with the hammer 9.

In the actuator 27, when an electric current is forced to flow through the solenoid coil 29, the plunger 31 moves upwardly so as to push up the hammer 9, thus making the hammer 9 pivotally move in the direction D. The push-up force, which is produced by the plunger 31 and is applied to the hammer 9, can be controlled in response to the magnitude of an electric current flowing through the solenoid coil 29.

In the condition in which no electric current flows through the solenoid coil 29, the plunger 31 is set to a prescribed position so as to serve as a regulation member for regulating further movement of the hammer 9 in the direction C.

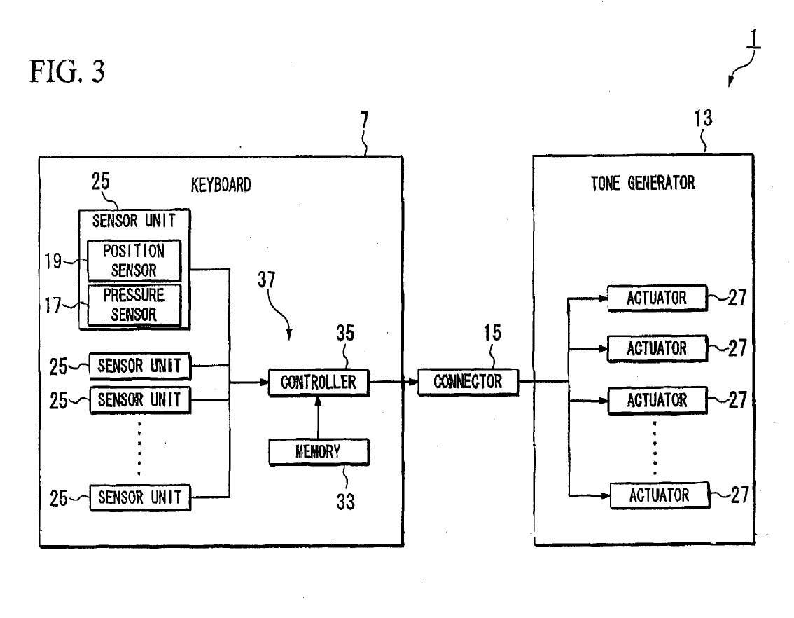

As shown in FIG. 3, the musical keyboard instrument 1 includes a memory 33 for storing reference data making the actuators 27 operate and the controller 35 for controlling the operations of the actuators 27 based on the key-depression signals output from the sensor units 25 and the reference data stored in the memory 33. The present embodiment is designed such that both of the memory J3 and the controller 35 are installed in the keyboard 7.

The reference data stored in the memory 33 form a data table representing the mutual correspondence (or relationship) between the key-depression signals and the drive control signals for controlling the operations of the actuators 27. The key-expression signals represent the key-expression pressure applied to the key 3 and the position of the key 3 being pivotally moved, both of which are detects by the sensor unit 25, as well as a velocity and an acceleration of the pivotal movement of the key 3. The controller 35 calculates the velocity and acceleration of the key 3 based on the detection result of the position sensor 19 representing the position the key 3 being pivotally moved.

The drive control signals represent the magnitude of an electric Current flowing through the solenoid coil 29 of the actuator 27, wherein they are related to the position, velocity, and acceleration of the hammer 9 that pivotally moves when being driven by the actuator 27.

The data table shows the relationship between the position of the key 3 and the position of the hammer 9 driven by the actuator 27. The relationship is determined in such a way that as the distance of the pivotal movement of the key 3 from its initial position in the direction B becomes large, the distance of the pivotal movement of the hammer 9 from its initial position in the direction D correspondingly becomes large.

The data table also shows the relationships between the velocity and acceleration of the key 3 in the direction B and the velocity and acceleration of the hammer 9. The relationships are determined in such a way that as the velocity and acceleration of the key 3 become high, the velocity and acceleration of the hammer 9 correspondingly become high.

The controller 35 makes a decision as to whether or not a key-depression operation using a player's finger is detected with respect to the key 3 on the basis of an output signal of the pressure sensor 17. The controller 35 accesses the Memory 33 so as to output a drive control signal to the actuator 27 on the basis of a key-depression signal output from the position sensor 19 of the key 3 on which the key-depression operation is detected, thus controlling the operation of the actuator 27 associated with the key 3. The drive control signal output from the controller 35 is transmitted to the actuator 27 via the connector 15.

The actuator 27, the memory 33, and the controller 35 form a drive control device 37, which drives the hammer 9 to strike the string 11 so as to generate a musical tone based on the key-depression signal that is output from the sensor unit 25 detecting the key-depression operation with respect to the key 3.

In the musical keyboard instrument 1 having the aforementioned constitution, when a player's finger depresses the key 3, which is thus pivotally moved in the direction B, the pressure sensor 17 detects a key-depression operation that is applied to the key 3 depressed by the player's finger so as to produce a detection result, which is then supplied to the controller 35. At this time, the position sensor 19 outputs a key-depression signal, based on which the controller 35 accesses the memory 33 so as to produce a drive control signal. Then, the controller 35 supplies the (rive control signal to the actuator 27 associated with the key 3 via the connector 15. The actuator 27 drives the hammer 9 to pivotally move in the direction D on the basis of the drive control signal. That is, the hammer 9 is driven by the actuator 27 so as to strike the sting 11, which thus generates a musical tone.

The musical keyboard instrument 1 of the present embodiment is designed such that the keyboard 7 and the tone generator 13 are electrically connected together via the connector 15 but are mechanically isolated from each other. This realizes a technological distinction between the conventionally-known acoustic keyboard instrument and the musical keyboard instrument 1, wherein the weight of the hammer 9 is not transmitted to the key 3 being depressed by the player's finger. This makes it possible for the string 11 to generate a musical tone by way of only the depression force applied to the key 3 of the keyboard 7. That is, it is possible to realize a brand-new key-touch sensation, which the player feels on the key 3 but which is not influenced by the weight of the hammer 9, in the key-depression operation. This makes it possible for the player to rapidly depress the keys 3 with relatively small depression force with ease; hence, a weak person can easily play the musical keyboard instrument 1.

Since the keyboard 7 and the tone generator 13 are mechanically isolated from each other, it is possible to easily replace the keyboard 7, which is connected to the tone generator 13, by simply detach ably attaching the connector 15. By appropriately replacing the keyboard 7, it is possible for the player to use another keyboard realizing different key-touch sensations in association with the same tone generator 13, thus generating desired musical tones. In other words, the player enjoys the freedom of selecting any type of the keyboard 7 realizing desired key-touch sensations suited to the player's preference in association with the same tone generator 13.

The present embodiment is designed such that both of the memory 33 and the controller 35 are installed in the keyboard 7; but this is not a restriction. Since the sensor units 25 output key-depression signals to the controller 35, the memory 33 and the controller 35 can be mechanically isolated from the keyboard 7. Of course, it is possible to install both of the memory 33 and the controller 35 in the tone generator 13, for example.

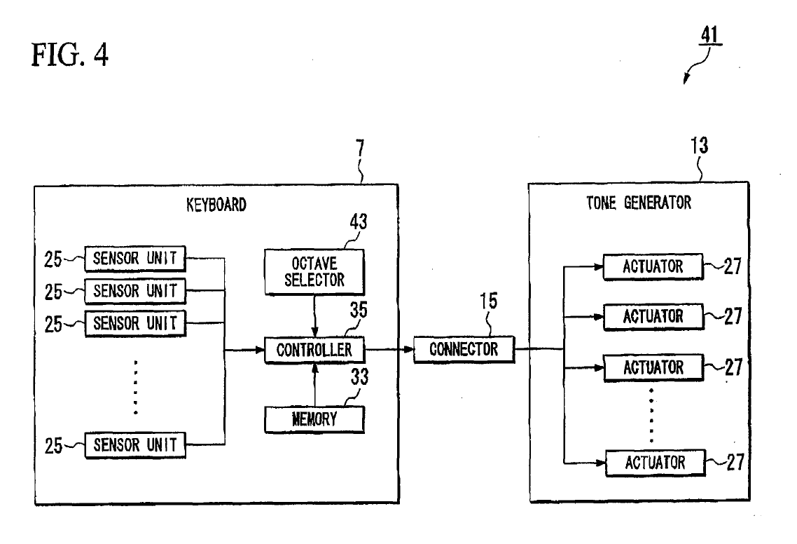

The present embodiment can be finder modified in a variety of ways. FIG. 4 shows the electrical constitution of a musical keyboard instrument 41 awarding to a first variation, in which an octave selector 43 is additionally installed in the keyboard 7 so as to select the strings 11 in the tone generator 13 in correspondence with the keys 3.

The octave selector 43 selects plural keys 3 in units of octaves in correspondence with sound sources. Suppose that the keyboard 7 having only twenty-four keys 3 corresponding to two octaves is connected to the tone generator 13 having eighty-eight strings 11 corresponding to seven octaves realized by a full-size acoustic piano. Herein, by operating the octave selector 43, the strings 11 corresponding to two octaves are assigned to the keys 3 corresponding to two octaves. In this constitution, the controller 35 outputs drive control signals to the actuators 27 in such a way that the hammers 9 selectively strike the strings 11 selected by the octave selector 43.

The musical keyboard instrument 41 allows the player to play a musical performance without greatly moving arms on the keyboard 7 because the octave selector 43 changes over the strings 11 being selected in correspondence with the keys 3 even when the number of the keys 3 installed in the keyboard 7 is smaller than the number of the strings 11 installed in the tone generator 13.

In addition, the musical keyboard instrument 41 can be configured in such a way that a plurality of keyboards 7 are connected to the same tone generator 13 via the connector 15. Alternatively, the musical keyboard instrument 41 allows plural players to select the strings 11 of different octaves by operating the octave selectors 43 installed in the keyboards 7; that is, it is possible for plural players to play a prescribed piece of music using the same tone generator 13 in a duet. In this case, plural players can use their own keyboards 7 realizing desired key-touch sensations suited to their preferences.

The present embodiment is designed such that the keyboard 7 is electrically connected to the tone generator 13 via the connector 15; but this is not a restriction That is, it is simply required that the controller 35 output drive control signals to the actuators 27. For example, it is possible to modify the present embodiment such that a wireless transmitter is installed in the keyboard 7, and a wireless receiver is installed in the tone generator 13. In this modification, the wireless transmitter transmits drive control signals output from the controller 35 to the wireless receiver, from which they are supplied to the actuators 27.

Each of the keys 3 is not necessarily equipped with the position sensor 19 for detecting the position of the pivotal movement thereof. It is simply required that each of the keys 3 be equipped with a motion sensor for detecting the motion thereof.

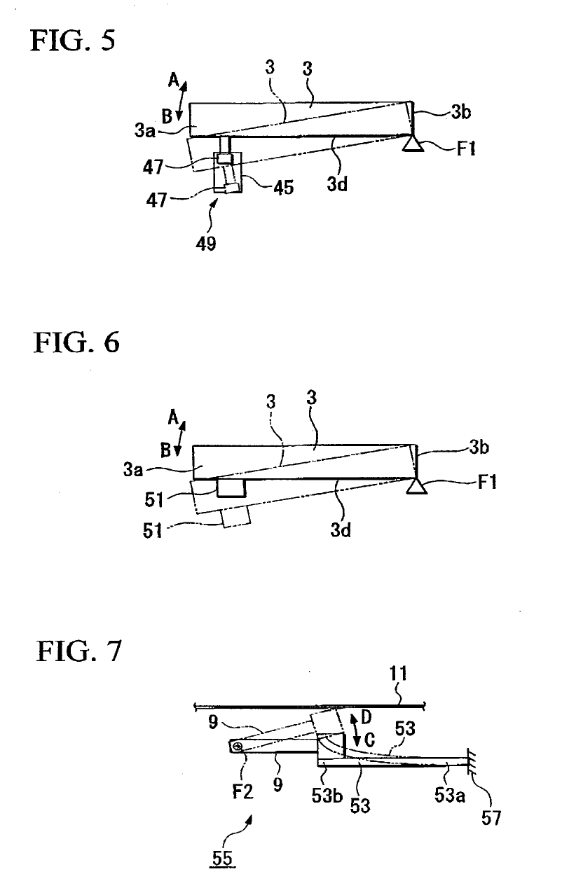

FIG. 5 shows essential parts of a musical keyboard intent according to a second variation. Herein, a velocity sensor 49 is installed in the musical keyboard instrument as the motion sensor. Specifically, the velocity sensor 49 is constituted of a coil 45, which is fixed in position beneath the front-end portion 3a of the key 3, and a magnet 47, which is fixed to the backside 3d of the key 3 in proximity to the front-end portion 3a and which moves inside of the coil 45 in response to the pivotal movement of the key 3. In the velocity sensor 49, induced electromotive force occurs in the coil 45 in response to the velocity of the pivotal movement of the key 3; hence, it is possible to directly detect the velocity of the pivotal movement of the key 3.

FIG. 6 shows essential parts of a musical keyboard instrument according to a third variation. Herein, an acceleration sensor 51 adapted to MEMS (Micro-Electro-Mechanical System) is installed in the musical keyboard Argument as the motion sensor. Specifically, the acceleration sensor 51 is attached to the backside 3d of the key 3 in proximity to the front-end portion 3a.

Each key 3 can be equipped with one of the position sensor 19, the velocity sensor 49, and the acceleration sensor 51. Alternatively, each key 3 can be equipped with at least two of the position sensor 19, the velocity sensor 49, and the acceleration sensor 51, which are appropriately combined together.

In the present embodiment, the actuator 27 is constituted of the Solenoid coil 29 and the plunger 31; but this is not a restriction. It is simply required that the actuator 27 be configured so as to make the hammer 9 pivotally move in the direction D on the basis of the drive control signal output from the controller 35. For this reason, the actuator 27 can be configured in the form of a polymer actuator, or it can be formed using the shape memory alloy, ultrasonic motor, electromagnetic motor, and surface-acoustic-wave motor, for example.

An example of the polymer actuator is formed in such a way that gold plating layers serving as electrodes are formed on both surfaces of a film composed of an ion-exchange resin. FIG. 7 shows essential parts of a musical keyboard instrument according to a fourth variation, wherein a polymer actuator 53 composed of an ion-exchange resin is installed in a tone generator 55 having a frame 57. A first end 53a of the polymer actuator 53, which lies in a plane direction of the ion-exchange resin, is fixed to the frame 57 of the tone generator 55, while a second end 53b is brought into contact with the lower side of the hammer 9. When a voltage is applied between the electrodes in response to a drive control signal, ions swell oh one surface of the ion-exchange resin, which is thus expanded in volume so that, as shown in FIG. 7, the polymer actuator 53 is deflected upwardly. Due to the deflected deformation of the polymer actuator 53, it is possible to drive the hammer 9 in the direction D.

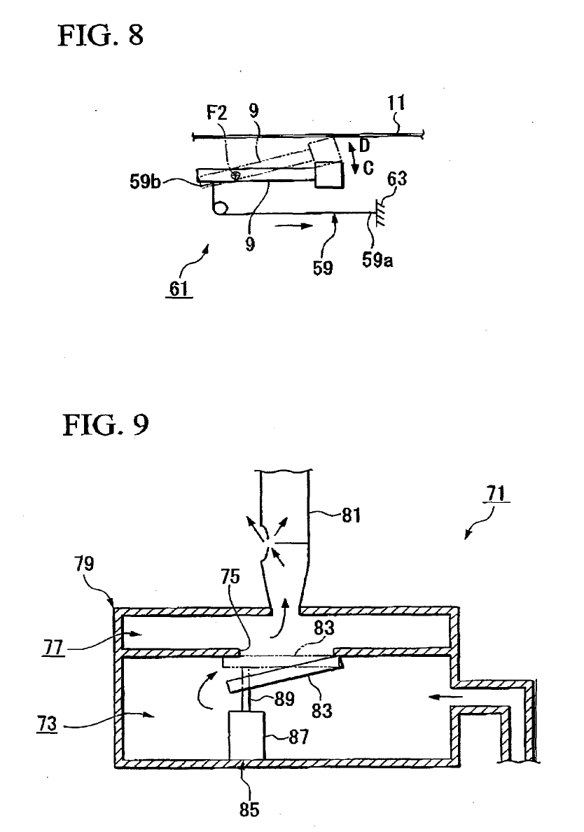

FIG. 8 shows essential parts of a musical keyboard instrument according to a fifth variation, wherein a linear shape memory wire (i.e., an actuator composed of a shape memory alloy) 59 is installed in a tone generator 61 having a frame 63. A first end 59a of the shape memory wire 59 is fixed to the frame 63 of the tone generator 61, while a second end 59b is fixed to the hammer 9 in such a way that the hammer 9 pivotally moves in the direction D due to the contraction of the shape memory wire 59. In this constitution, the shape memory wire 59 is electrified in response to a drive control signal so that the shape memory wire 59 is contracted, whereby the hammer 9 is driven in the direction D due to the contraction of the shape memory wire 59.

In the present embodiment, similar to the tone-generation mechanism of an acoustic piano, the tone generator 13 is equipped with the hammers 9 and the strings 11; but this is not a restriction. It is simply required that the tone generator 13 be formed to generate musical tones in response to operations of operating members. When the musical keyboard instrument is designed to simulate a harpsichord, the tone generator 13 is equipped with plectra for picking strings similar to string of the harpsichord. In this modification, plectra can be appropriately driven bay means of the aforementioned actuators 27, 53, and 59 so as to generate musical totes.

FIG. 9 shows essential parts of a musical keyboard instrument according to a sixth variation, wherein a tone generator 71 simulating a tone-generation mechanism of a pipe organ is constituted of a main chamber 73 interconnected to an air blower (not shown), a wind box having a plurality of individual chambers 77, which are interconnected to the main chamber 73 via a hole 75, a plurality of sound pipes 81 interconnected to the individual chambers 77 respectively, and a palette (or an operating member) that opens and closes the hole 75 so as to change over blowing into the sound pipe 81.

The palette 83 is normally pressed by a spring (not shown) so as to close the hole 75. The tone generator 71 is equipped with an actuator 85 that drives the palette 83 to open the hole 75. The actuator 85 is constituted of the solenoid coil 81 and the plunger 89, wherein the distal end of the plunger 89 is fixed to the palette 83.

In the aforementioned constitution, the hole 75 is pressed upwardly by the spring so as to close the hole 75 when no electric current flows through the solenoid coil 87. When an electric current flows through the solenoid coil 87, the palette 83 is driven so as to open the hole 75. Similar to the musical keyboard instrument 1, the electrification control of the solenoid coil 87 is performed based on drive control signals output from the controller 35. When the hole 75 is opened, an air flow caused by the air blower is transmitted into the sound pipe 81 via the individual chamber 77, so that the sound pipe 81 generates a musical tone.

The palette 83 is not necessarily driven by means of the actuator 85 having the aforementioned constitution. That is, the actuator 85 can be replaced with the polymer actuator 53 and the shape memory wire 59 as well as the ultrasonic motor, electromagnetic motor, and surface-acoustic-wave motor, for example.

As described above, the tone generators 13 and 71 can be designed to simulate various tone-generation mechanisms realizing various tone colors such as an acoustic piano, a harpsichord, and a pipe organ. Therefore, it is possible to easily replace the tone generators 13 and 71, which are detachably attached to the keyboard 7, with various tone generators realizing various tone colors. That is, replacement of the tone generators 13 and 71 allows the player to freely select various tone colors without changing the key-touch sensations of the keys 3 of the keyboard 7.

In the present embodiment, the drive control device 37 includes the memory 33 that stores the relationship between key-depression signals and drive control signals; but this is not a restriction. It is simply required that the hammers 9, the palette 83, and plectra be driven in response to key-depression signals output from the sensor units 25.

Lastly, the present invention is not necessarily limited to the present embodiment and its variations; hence, the present embodiment can be further modified within the scope of the invention defined by the appended claims.

What is claimed is:

1. A musical keyboard instrument comprising:
a keyboard having a plurality of keys that pivotally move about a frame;
a tone generator having a plurality of operating members allowing musical tones to be generated in response to the plurality of keys being depressed;
a plurality of key-depression detection devices that are arranged for the plurality of keys so as to detect key-depression operations applied to the keys; and
a drive control device for driving each of the operating member so as to generate a musical tone in response to a key-expression signal output from each of the key-depression detection devices upon detection of a key-depression operation applied to each of the keys.

2. A musical keyboard instrument according to claim 1, wherein the operating member is a hammer for striking a string so as to generate a musical tone.

3. A musical keyboard instrument according to claim 1, wherein operating member is a plectrum for striking a string so as to generate a musical tone.

4. A musical keyboard instrument according to claim 1, wherein the operating member is a palette that opens or closes a hole so as to control an air flow blown into a sound pipe.

5. A musical keyboard instrument according to claim 1, wherein the drive control device includes a plurality of actuators, which are installed in the tone generator so as to drive the plurality of operating members, a memory for storing relationships between the key-depression signals and the drive control signals, and a controller for controlling the actuators in response to the drive control signals, which are read from the memory in response to the key-depression signals output from the key-depression detection devices upon detection of key-depression operations applied to the keys.

6. A musical keyboard instrument according to claim 1 further comprising an octave selector for selecting the plurality of operating members in units of octaves in correspondence with the plurality of keys included in the keyboard, wherein the drive control device drives the operating members selected by the octave selector so as to generate musical tones.

7. A musical keyboard instrument according to claim 1, wherein the keyboard is detachably attached to the tone generator via a connector.
